(19) United States
(12) Patent Application Publication
(10) Pub. No.: US 2015/0300269 A1
(43) Pub. Date: Oct. 22, 2015

(54) DEVICE FOR POSITIONING A MEMBER FOR CONTROLLING AN INJECTION PUMP

(71) Applicant: SOCIETE DE MOTORISATION AERONAUTIQUES, Bourges (FR)

(72) Inventor: Florian Nicolas VARY, Melun (FR)

(21) Appl. No.: 14/647,707

(22) PCT Filed: Nov. 26, 2013
(86) PCT No.: PCT/FR2013/052860

§ 371 Date: May 27, 2015

(30) Foreign Application Priority Data
Nov. 27, 2012 (FR) 1261305

(51) Int. Cl. F02D 11/10; G05G 1/04

(52) U.S. Cl. CPC F02D 11/10; G05G 1/04

(57) ABSTRACT

A device for positioning a member for controlling an injection pump for a piston engine, includes a lever for controlling the power of the engine; a mechanical housing including a first mechanical device in communication with the control lever and the control member, the first mechanical device for positioning the control member in a position according to the power controlled by the control lever; a device for compensating for a position, including a position sensor of the control lever for measuring the position of the control lever, a position sensor of the control member for measuring the position of the control member, an electronic computer for calculating the position difference between a measured position of the control lever and a measured position of the control member, and an actuator controlled by the electronic computer, the actuator including a control shaft to compensate for the calculated position difference.

The present invention relates to a device for positioning a member for controlling a fuel injection pump for aircraft piston engines.

It is known to use a control device for positioning a member for controlling an injection pump in order to regulate the power of an aircraft engine. The position of the member for controlling the injection pump acts on the fuel flow which is delivered to the engine and thus has an influence on the power of the engine.

Such a control device comprises a lever for controlling the power of the engine (also known as throttle lever) enabling the pilot to position the control member via mechanical control means or via electrical control means.

It should be noted that these control means are independent of each other.

The pilot normally uses electrical control means. In the event of failure of the electrical control means, the pilot then uses mechanical control means in order to assure the minimum power requirement of the engine.

For safety reasons, the mechanical control means are designed to assure the regulation of the power of the engine if said engine is compromised by the breakdown of one or more component(s) of the electrical control means or instead if the electrical supply necessary for the operation of the electrical control means fails. In other words, the mechanical control means enable the pilot to control the power of the engine uniquely by means of mechanical parts connecting the control lever to the member for controlling the injection pump.

The electrical control means make it possible to ease the workload of the pilot thanks to the use of electrical and electronic components. These electrical control means are suitable for acting on the member for controlling the injection pump according to the power demand of the pilot as well as the parameters measured on the engine and/or the aircraft. More particularly, the electrical control means control the position of the member for controlling the injection pump by means of an electric actuator controlled by an electronic computer. The latter interprets the fixed power set point of the engine desired by the pilot through a potentiometric sensor placed at the level of the throttle lever. According to the operating conditions of the engine measured by a series of sensors mounted on the engine, the computer enslaves this electric actuator in order to satisfy the power of the engine desired by the pilot. This enslavement is achieved thanks to a contactless linear sensor of inductive type measuring the position of the member for controlling the injection pump. The electric actuator is installed in a mechanical housing mounted on the injection pump and is thus directly exposed to the vibratory environment thereof.

A drawback resides in that the electrical control means comprise an electric actuator which is positioned in a mechanical housing integral with the injection pump. This assembly exposes the electric actuator to the vibratory environment of the injection pump which imposes regular maintenance actions on the electric actuator. Another drawback of such a device resides in that the use of the mechanical control means does not make it possible to reach the maximum power of the engine.

The aim of the device of the invention is thus more particularly to overcome the drawbacks of the aforementioned prior art. In this context, the invention aims to propose a device for positioning a member for controlling an injection pump making it possible in particular to reach a satisfactory precision of the power produced by an aircraft engine.

To this end, the invention relates to a device for positioning a member for controlling an injection pump for a piston engine comprising:
a lever for controlling the power of the engine,
a mechanical housing comprising first mechanical means engaging with said control lever and said control member, said first mechanical means being, suitable for positioning said control member in a specific position according to said power controlled by said control lever,

said device also comprises means for compensating for a position comprising:
a position sensor of said control lever for measuring the position of said control lever,
a position sensor of said control member for measuring the position of said control member,
an electronic computer for calculating the position difference between a measured position of said control lever and a measured position of said control member, and
an actuator enslaved by said electronic computer, said actuator comprising a control shaft in order to compensate for said calculated position difference.

Thanks to the compensation means, the position of the control member corresponds with precision to the specific position controlled by said control lever and thus makes it possible to obtain an engine power corresponding with precision to the engine power desired by the pilot.

For the remainder of the description, maximum power of the engine is taken to mean the certified maximum power profile of the engine in its flight envelope. Limitations of the engine are taken to mean all the operating limits declared by the certification of the engine.

The device for positioning a member for controlling an injection pump according to the invention may also have one or more of the characteristics below, considered individually or according to any technically possible combinations thereof.

In a particular non-limiting embodiment, the compensation means comprise means for measuring the position of the control shaft, said position of said control shaft being used by the electronic computer to carry out the compensation.

In a particular non-limiting embodiment, the mechanical housing comprises second mechanical means engaging with the control shaft of the electric actuator and the control member, said second mechanical means being suitable for transmitting the compensation of the control shaft to the control member.

In a particular non-limiting embodiment, the compensation means comprise a switching housing suitable for powering on or powering off the electric actuator.

In a particular non-limiting embodiment, the positioning device comprises a device for indicating the powering on or powering off of the electric actuator.

In a particular non-limiting embodiment, the positioning device comprises a device for indicating the coherence between the position of the control lever and a flight phase.

In a particular non-limiting embodiment, the electronic computer comprises application software suitable for verifying the state:
of the position sensor of the control lever,
of the position sensor of the control member,
of the means for measuring the position of the control shaft.

In a particular non-limiting embodiment, the mechanical housing comprises a return device suitable for positioning the control shaft in a so-called disengagement position when the electric actuator is powered off.

In a particular non-limiting embodiment, the second mechanical means comprise a desmodromic control system preventing the transmission of vibration from the mechanical housing to the electric actuator.

In a particular non-limiting embodiment, the control lever comprises a first graduation for controlling first mechanical means and a second graduation for controlling second mechanical means.

Other characteristics and advantages of the invention will become clear from the description that is given thereof hereafter, as an indication and in no way limiting, with reference to the appended figures, among which:

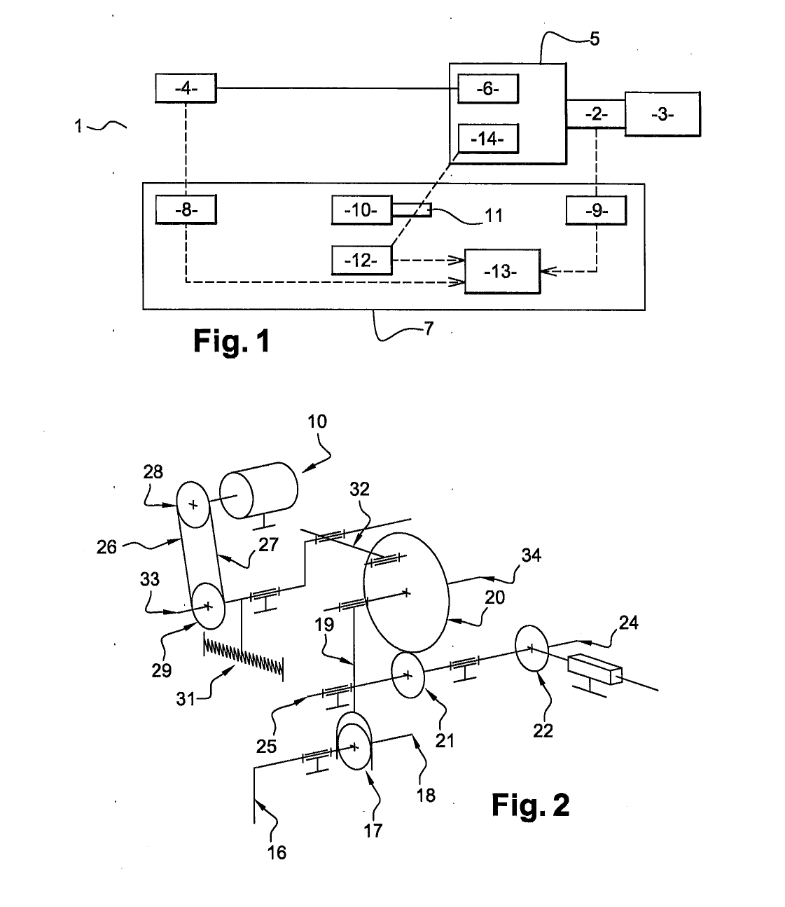

FIG. 1 illustrates a non-limiting embodiment of a device for positioning a member for controlling an injection pump for a piston engine according to the invention,

FIG. 2 schematically illustrates a non-limiting embodiment of a mechanical housing which comprises a positioning device according to that represented in FIG. 1,

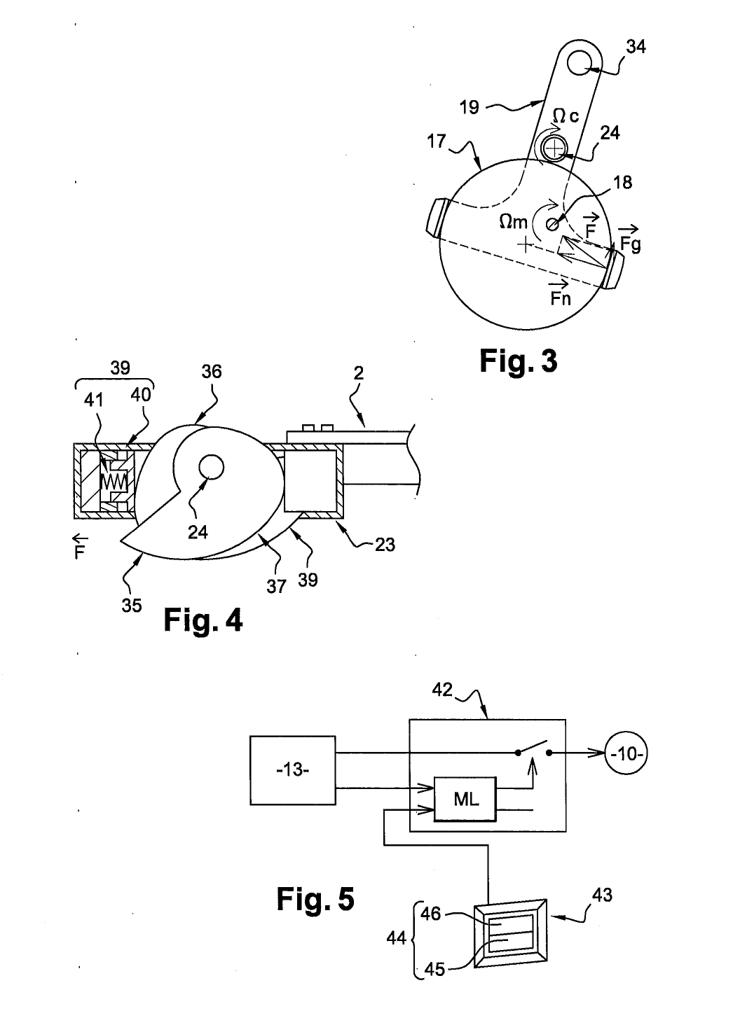

FIG. 3 schematically illustrates a non-limiting embodiment of an anti-return system that comprises a positioning device according to that represented in FIG. 1,

FIG. 4 schematically illustrates a non-limiting embodiment of a cam system which comprises a positioning device according to that represented in FIG. 1,

FIG. 5 schematically illustrates a non-limiting embodiment of a switching housing and a device for indicating the powering on or powering off with which a positioning device according to that represented in FIG. 1 is equipped,

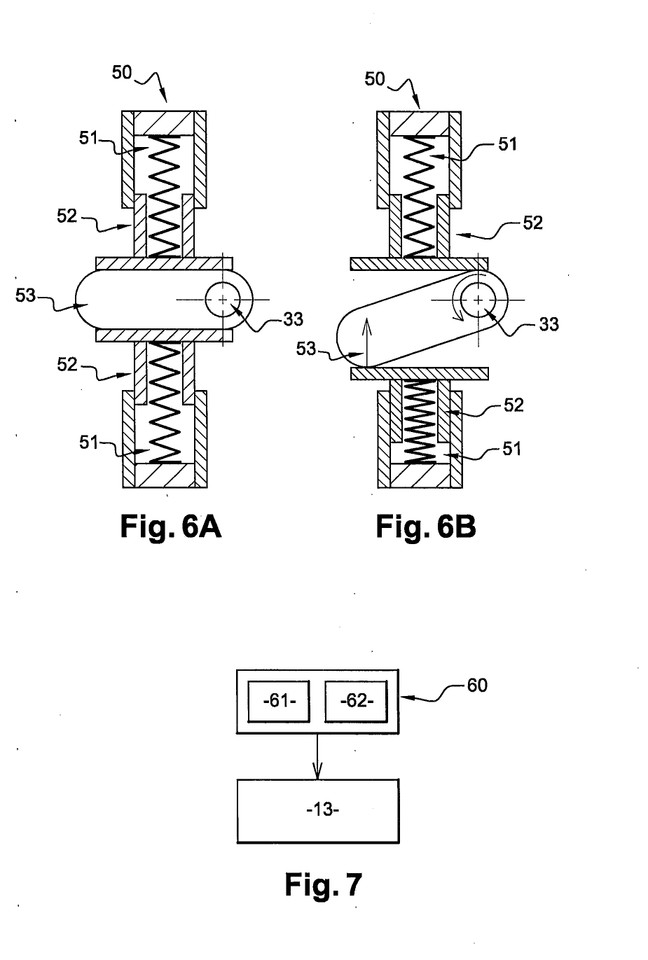

FIGS. 6A and 6B schematically illustrate a non-limiting embodiment of a return device which a positioning device according to that represented in FIG. 1 comprises,

FIG. 7 schematically illustrates a non-limiting embodiment of a device for indicating the coherence with which a positioning device according to that represented in FIG. 1 is equipped,

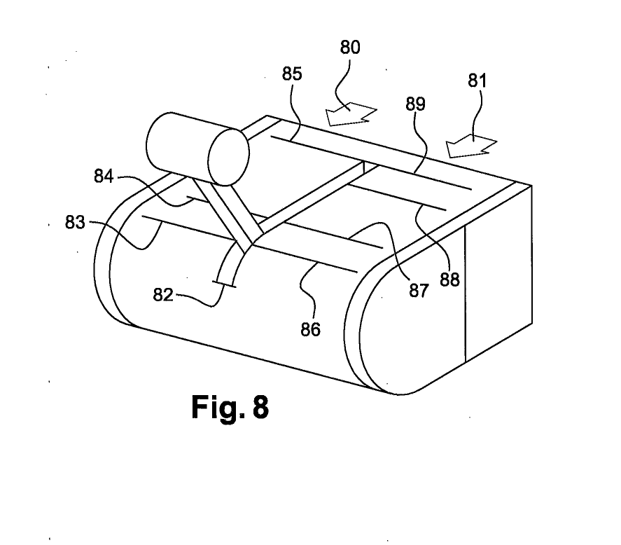

FIG. 8 illustrates in a schematic manner a lever for controlling power which comprises a positioning device according to that represented in FIG. 1.

For reasons of clarity, only components essential for the understanding of the invention have been represented, and this has been done without respect for scale and in a schematic manner.

FIG. 1 represents a non-limiting embodiment of a device 1 for positioning a member 2 for controlling an injection pump 3 for a piston engine according to the invention.

The device 1 comprises in particular:
a lever 4 for controlling the power of the engine,
a mechanical housing 5 comprising first mechanical means 6 engaging with the control lever 4 and the control member 2, the first mechanical means 6 being suitable for positioning the control member 2 in a specific position according to the power controlled by the control lever 4,
compensation means 7.

The compensation means 7 comprise:
a position sensor of the control lever 8 for measuring the position of the control lever 4,
a position sensor of the control member 9 for measuring the position of the control member 2,
an electric actuator 10 comprising a control shaft 11 to control the control member 2, the actuator 10 being for example a servo-actuator,
means 12 for measuring the position of the control shaft 11,
an electronic computer 13 for calculating the position difference between the measured position of said control lever 4 and the measured position of the control member 2, the actuator 10 being enslaved by the electronic computer 13 so as to be able to compensate for the calculated position difference.

In other words, to carry out this compensation, the electronic computer 13 performs an enslavement in position of the control shaft 11 of the actuator 10 using three position items of information:
a measurement of the position of the control lever 4,
a measurement of the position of the control shaft 11, and
a measurement of the position of the control member 2.

In order to be able to carry out this compensation, the mechanical housing 5 comprises second mechanical means 14 engaging with the control shaft 11 of the electric actuator 10 and the control member 2, the second mechanical means 14 being suitable for transmitting the compensation of the control shaft 11 to the control member 2.

FIG. 2 schematically illustrates a non-limiting example of the mechanical housing 5 comprising the first mechanical means 6 and the second mechanical means 14.

More particularly, the first mechanical means 6 comprise in particular:
a lever-throttle lever 16,
an eccentric-throttle lever 17 arranged on the axis 18 of the lever-throttle lever 16,
a satellite-holder fork 19 engaging with the eccentric-throttle lever 17 and a satellite 20,
a planetary 21 meshed with the satellite 20,
a cams system 22 comprising in particular a control cam and a return cam (illustrated in FIG. 4), and
a slide 23 fixed onto the member 2 for controlling the injection pump.

The first mechanical means 6 alone enable the pilot to control the power of the engine uniquely through the intermediary of mechanical components connecting the lever 4 for controlling the power of the engine to the member 2 for controlling the injection pump. The action of the pilot on the lever 4 for controlling the power drives a push-pull cable (not represented) connected to the lever-throttle lever 16 of the mechanical housing 5. Said lever-throttle lever 16 drives the rotation of the eccentric-throttle lever 17 around the axis 18 of the lever-throttle lever. The rotation of the eccentric-throttle lever 17 around this axis 18 brings about the tipping of the satellite-holder fork 19 around the axis 24 of the cams system 22. The tipping of the satellite-holder fork 19 then induces a rotation of the satellite 20 around the axis 24 of the cams system 22, the satellite then drives the planetary 21 in rotation. The axis of the planetary 25 is integral with the axis 24 of the cams system 22 such that the rotation of the axis 25 of the planetary 21 drives the rotation of the cams system 22 (illustrated later) which controls in translation the member 2 for controlling the injection pump via the slide 23.

The second mechanical means 14 comprise:
a desmodromic control system comprising a first sheathed flexible cable 26 and a second sheathed flexible cable 27, a control pulley 28 and a pump pulley 29,
an arm 30 driven in rotation by the pump pulley 29,
a device for returning the actuator to a so-called disengagement position 31,
a connecting rod 32 controlled by the arm 30, the connecting rod 32 engaging with the satellite 20,
the planetary 21,
the cams system 22, and
the slide 23 fixed onto the member 2 for controlling the injection pump.

More particularly, the control pulley 28 is fixed onto the control shaft 11 of the electric actuator 10 and the pump pulley 29 is fixed onto the rotation axis of the arm 33. Each cable 26, 27 comprises a first end wound in a groove around the control pulley 28 and a second end wound in a groove around the pump pulley 29. The first cable 26 drives these pulleys 28 and 29 in a direction of rotation contrary to the second cable 27 which drives them in the opposite direction.

The tension of the cables is achieved by the flexible sheaths of which one of the two ends is fixed onto a frame connected to the electric actuator and the other is fixed onto the mechanical housing.

The desmodromic system makes it possible to position the electric actuator 10 in a zone isolated from the vibrations that are present at the level of the mechanical housing 5 or present at the level of the injection pump 3.

The desmodromic system makes it possible to reduce the mechanical clearances between the outlet of the actuator 10 and the member 2 for controlling the injection pump 3 while preventing vibrations present at the level of the mechanical housing 5 or the injection pump 3 propagating to the electric actuator 10. The absence of vibrations and mechanical clearances confers a significant lifetime to the electric actuator 10.

As a reminder, the second mechanical means 14 engage with the control shaft 11 of the electric actuator 10 and the control member 2. Thus, when the electric actuator 2 drives in rotation the arm 30 around its axis 33 thanks to the desmodromic control system, the connecting rod 32, drives in rotation the satellite 20 around the satellite axis 34 which remains fixed. The rotation of the satellite 20 drives in rotation the planetary 21 around the axis 24 of the cams system 22. The planetary 21 being mounted on the same axis of rotation as the axis 24 of the cams system 22, the rotation of the planetary 21 drives the rotation of the cams system 22 which drives in translation the slide 23 fixed onto the member 2 for controlling the injection pump.

In a particular embodiment, the second mechanical means 14 comprise an anti-return system which prevents the movement of the electric actuator 10 propagating to the control lever 4. This particularity guarantees that the movements generated by the electric actuator 10 are uniquely transmitted to the member 2 for controlling the injection pump and not to the control lever 4.

In a non-limiting embodiment illustrated in FIG. 3, said anti-return system is realised by the association of the satellite-holder fork 19 and the eccentric-throttle lever 17. In fact, the electric actuator 10 drives the satellite 20 in rotation through the intermediary of the connecting rod 32. The driving efforts are transmitted to the satellite-holder fork 19 via the satellite axis 34 thereby creating on the fork 19 a torque bc around the axis of the cams system 22 which is fixed. This torque bc applies to the contact surface between the satellite-holder fork 19 and the eccentric throttle lever 17, a force Ft composed of the normal supporting effort Fn of the fork 19 on the eccentric 17 as well as a friction or sliding force Fg. Given the orientation of this effort Ft and the position of the throttle lever axis 18 around which pivots the eccentric 17, an extremely low torque km is then transferred onto the eccentric 17. These residual efforts propagated from the actuator 10 onto the lever-throttle lever 16 are countered by the friction efforts of the kinematic chain upstream of the lever-throttle lever 16 comprising the push-pull cable and the lever 4 for controlling engine power. Thus, the control lever 4 remains fixed when the control shaft 11 pivots. In the opposite direction to the efforts, the anti-return system enables a complete transmission of the movements of the lever-throttle lever 16 into pivoting movements of the satellite-holder fork 19 around the axis 24 of the cams system.

In a non-limiting example illustrated in FIG. 4, the cams system 22 comprises a control cam 35 and a return cam 36.

The axis of rotation 24 of the cams system 22 is the same for the control cam 35 and the return cam 36. The axis of rotation 24 of the control cam 35 is perpendicular to the direction of translation of the control member 2. The external profile 37 of the control cam 35 is maintained in contact against a flat surface 38 of the slide 23 integral with the control member 2. The shape of the external profile 37 of the control cam 35 in contact with the flat surface 38 of the slide 23 and the angle of rotation of the axis 24 make it possible to define the movement of the member 2 for controlling the injection pump.

The position sensor for the position of the control member 9 is thus placed at the level of the axis of rotation 24 of the control cam 35. In fact, through knowledge of the profile 37 of the control cam 35 and the angle of rotation of the axis 24 of the cams system 22, the electronic computer 13 can perform a calculation making it possible to estimate the linear position of the control member 2. This assembly reduces to the strict possible minimum the number of mechanical parts between the position sensor of the control member 9 and the member 2 for controlling the injection pump. Consequently, the measurement of the position of the control member 2 is precise.

Another interest is to regulate, by the choice of the profile 37 of the control cam 35, the power variation sensitivity of the engine according to the variation of the position of the throttle lever 8.

This control cam 35 is maintained in contact with the flat surface 38 of the slide 23 thanks to a take up of play system 39 operating on the return cam 36. The external profile 39 of the return cam 36 is complementary to the external profile 37 of the control cam 35. Whereas the control cam 35 makes it possible to move the slide 23 in one direction, the return cam 36 makes it possible to move the slide in the opposite direction.

In a non-limiting example, the take up of play between the slide 23 and the control cam 35 is achieved by the take up of play system 39 and is composed of a plunger 40 integral with the slide 23 and pressed against the return cam 36 by a compression spring 41 resting on the slide 23. The spring 41 exerts an effort F tending to maintain the flat surface 38 in contact with the control cam 35.

In other words, the position of the control member 2 is determined by the angular position of the axis 24 of the cams system 22. This position may only be modified by the rotation of the satellite 20 which is meshed in the planetary 21 integral with the axis 24 of the cams system 22. The rotation of the satellite 20 is a combination of two rotations.

A first rotation is that of the satellite 20 around its axis 34, this is brought about by the electric actuator 10.

A second rotation is that of the satellite 20 around the axis 24 of the cams system 22, this is brought about by an action of the pilot on the power control lever 4.

Consequently, the position of the member 2 for controlling the injection pump is a composition of the position of application of power 4 controlled by the pilot, and of the electric actuator 10 controlled by the electronic computer 13.

Furthermore, the means 12 for measuring the position of the control shaft 11 may be formed for example by a sensor suitable for supplying the angular position of the control shaft 11 of the electric actuator. In a different embodiment, the electric actuator 10 is itself capable of supplying the angular position of its control shaft 11 to the electronic computer 13.

The interest of measuring both the position of the control member 2 via the sensor for measuring the position of the control member 9, and also the position of the control shaft 11 of the actuator 10 is to be able in particular to correct enslavement errors of the electric actuator 10 and reach a satisfactory precision of the power produced by the engine when the compensation means 7 are activated, the compensation means 7 being activated when the electric actuator 10 is powered on.

In a particular embodiment, the electronic computer 13 comprises application software suitable for verifying the state:
of the position sensor of said control lever 8,
of the position sensor of said control member 9,
of the means 12 for measuring the position of the control shaft.

The correct operation of these sensors 8, 9 and measurement means 12 may be verified in different non-exclusive manners:
the sensors 8, 9 and/or measurement means 12 may be all or in part equipped with redundant measurement channels making it possible to detect the breakdown of a sensor 8, 9 or measuring means 12 by comparison of its different measurement channels, the coherence of the measurements carried out simultaneously on the two sensors 8, 9 and the measurement means 12 may be tested given the mechanical connection existing between them, which makes it possible to detect the failure of at least one of the sensors 8, 9 or measuring means 12 among the three. This verification is carried out in the application software installed in the electronic computer 13.

In the event of failure of at least one of the measuring means 12 or one of the two sensors 8, 9, the electric actuator 10 may be powered off by a switching housing 42 that comprises the device 1.

In an embodiment, the device 1 comprises a switching housing 42 (illustrated in FIG. 5) suitable for power on or powering off the electric actuator 10.

The switching housing 42 assures the powering off of the electric actuator 10:
in the event of failure of the compensation means 7, or
consecutively to a request to deactivate the compensation means 7 by the pilot through a switch 43 engaging with the switching housing 42.

The switching housing 42 is capable of powering off the electric actuator 10 without the intervention of the pilot thanks to one or more signals delivered to the switching housing 42 by the electronic computer 13. Different types of signals may be employed in order to enable the switching housing:
to be informed of a failure detected by the electronic computer 13 equipped with application software detailed hereafter,
to detect itself the operating state of the electronic computer 13.

To cover the first situation, signals in which one of the values represents a breakdown condition may be transmitted by the computer 13 to the switching housing 42.

To cover the second situation, the signal may be continuous and periodic signals in which the variations of certain of their characteristics expected by the switching housing 42 correspond to breakdown modes of the electronic computer 13.

Logic means ML implemented in the switching housing 42 assure the full authority of the pilot to deactivate the electric actuator 10 whatever the signals coming from the electronic computer 13. Moreover, this logic may prevent the pilot from activating the electric actuator 10 if a breakdown state has been signalled to the switching housing 42 or instead has been detected by the switching housing 42.

In an embodiment, the switching housing 42 is protected against effects induced by lightning in order to preserve this function of powering off the electric actuator 10 in the event of lightning striking the aircraft comprising the device 1.

When the electric actuator 10 is powered off, the device 1 operates uniquely with the first mechanical means 6 and the pilot cannot force the powering on of the electric actuator 10, when the compensation means 7 are detected as faulty by the electronic computer 13. In fact, the electronic computer 13 can cut off the electrical supply of the actuator 10 directly.

The device 1 according to the invention may also comprise a device for indicating the powering on or the powering off 44 of the electric actuator 10. These may be formed by an indicator light controlled by the switching housing 42 indicating that the compensation means are faulty or that the pilot has himself deactivated them.

In an example illustrated in FIG. 5, said indication device 44 comprises two indicator lights:
a first indicator light 45 which is lit when the compensation means 7 are in good working order and which is not lit when the compensation means 7 are faulty.
a second indicator light 46 which is lit when the first mechanical means 6 alone are active (uniquely in the event where there is no general electrical breakdown on board the aircraft).

When the electric actuator 10 is powered off, the electric actuator 10 takes a so-called disengagement position. This disengagement position corresponds to a zero compensation on the position of the member 2 for controlling the injection pump defined by the first mechanical means 6.

When the electric actuator 10 is not supplied electrically, it no longer delivers engine torque and its control shaft 11 returns to a disengagement position thanks to a return device 50 (illustrated in FIGS. 6A and 6B) integrated in the mechanical housing 5.

It should be noted that FIG. 6A illustrates the disengagement position.

This return device 50 comprises two springs 51 situated opposite each other. Each spring 51 maintains a plunger 52 in contact against a single and same cam 53 called return cam actuator. This return cam actuator 53 may be mounted on the axis of the arm 33. Consequently, outside of the disengagement position (FIG. 6A), one of the two springs 51 is compressed and delivers a sufficient effort to return the return cam 53 to equilibrium in disengagement position when the electric actuator 10 is no longer supplied electrically and that it no longer transmits any torque. This return movement of the return cam 53 is transmitted to the output axis of the electric actuator 11 through the desmodromic control system via flexible cables.

The device 1 may also comprise a device for indicating the coherence 60 between the position of the lever 4 for controlling the power of the engine and a flight phase (FIG. 7). To do so, the device 60 engages with the electronic computer 13 and is able to alert the pilot to an incoherence of positioning of the control lever 4 vis-à-vis the flight phase or to confirm to the pilot that the control lever 4 is suitably positioned.

Said indication device 60 may be formed by light indicators 61, 62 installed in the cockpit of the aircraft.

In a particular embodiment illustrated in FIG. 8, the control lever 4 comprises two graduations, a first graduation 80 corresponding to the operation of the first mechanical means 6 alone, that is to say without the electronic actuator 10 and thus without the second mechanical means 14. A second graduation 81 used when the electric actuator 10 is activated.

The first graduation 80 comprises:
a stop 82 corresponding to the stoppage of the engine. In this position, the injection pump does not deliver fuel to the engine and thus does not enable said engine to operate,
a lower stop 83 assuring a distinction of action between an engine power variation request and an engine stoppage request,
an intermediate stop 84 corresponding to a placing in idling of the engine during a flight phase of the aircraft. Its function is to assure an idling speed without risk of extinction of the engine,
an upper stop 85, the position of which is sufficient to make it possible to reach the maximum power of the engine over its whole operating envelope.

The second graduation 81 comprises:
a first idling stop 86 corresponding to the idling speed of the engine when the aircraft is on the ground,
a second idling stop 87 corresponding to an idling request when the aircraft is in flight. This differentiation of idling speeds according to the phases of use of the engine makes it possible to achieve an idling without risk of extinction of the engine over its whole in flight operating envelope, while delivering a sufficiently low idling power to assure an easy landing of the aircraft whatever the airfield and the ambient conditions that reign there. And at the same time makes it possible to guarantee a continuity of the operation of the engine during a powering off of the electric actuator 10 in flight and at low engine speed,
a first full throttle stop 88. This position guarantees the non-overrun of the engine limitations, in particular in the event of deactivation of the compensation means 7. This stop 88 guaranteeing the respect of the limitations of the engine is to be used for all flight phases other than critical phases, a second full throttle stop 89 guaranteeing the delivery of power at least equal to the maximum power of the engine, in particular in the event of an unexpected deactivation of the compensation means 7. The second full throttle stop 89 guaranteeing the maximum power of the engine is to be used for the critical flight phases, i.e. for situations during which the aircraft has reduced safety margins linked to its low speed or low altitude (i.e. take off and reapplying power at low altitude).

1. A positioning device for positioning a control member for controlling an injection pump for a piston engine, the positioning device comprising:
a control lever for controlling a power of the piston engine;
a mechanical housing comprising a first mechanical device in communication with said control lever and said control member, said first mechanical device configured to position said control member in a specific position according to said power controlled by said control lever, and
a compensation device configured to compensate for a position, the compensation device comprising:
a position sensor of said control lever for measuring a position of said control lever,
a position sensor of said control member for measuring a position of said control member,
an electronic computer for calculating a position difference between a measured position of said control lever and a measured position of said control member, and
an electric actuator controlled by said electronic computer, said electric actuator comprising a control shaft to compensate for said calculated position difference.

2. The positioning device according to claim 1, wherein the compensation device comprises a position sensor for measuring a position of said control shaft, said measured position of said control shaft being used by said electronic computer to carry out said compensation.

3. The positioning device according to claim 1, wherein the mechanical housing comprises a second mechanical device in communication with the control shaft of the electric actuator and the control member, said second mechanical device configured to transmit the compensation of the control shaft to the control member.

4. The positioning device according to claim 1, wherein the compensation device comprises a switching housing for powering on or powering off the electric actuator.

5. The positioning device according to claim 4, further comprising a device for indicating the powering on or the powering off of the electric actuator.

6. The positioning device according to claim 1, further comprising a device for indicating a coherence between the position of the control lever and a flight phase.

7. The positioning device according to claim 2, wherein the electronic computer comprises application software for verifying a state:
of the position sensor of the control lever,
of the position sensor of the control member,
of the position sensor for measuring the position of the control shaft.

8. The positioning device according to claim 1, wherein the mechanical housing comprises a return device for positioning the control shaft in a disengagement position when the electric actuator is powered off.

9. The positioning device according to claim 1, wherein the second mechanical device comprises a desmodromic control system configured to prevent a transmission of vibration from the mechanical housing to the electric actuator.

10. The positioning device according to claim 3, wherein the control lever comprises a first graduation system configured to control the first mechanical device and a second graduation system configured to control the second mechanical device.
